(19) United States
(12) Patent Application Publication
(10) Pub. No.: US 2008/0271644 A1
(43) Pub. Date: Nov. 6, 2008

(54) Method for the Production of High-Strength, Acid-Resistant Concrete

(75) Inventors: Suz-chung Ko, Lenzburg (CH); Moussa Baalbaki, Moeriken (CH); Juraj Gebauer, Veltheim (CH)

Correspondence Address: CHAPMAN AND CUTLER, 111 WEST MONROE STREET, CHICAGO, IL, 60603, US

(73) Assignee: Holcim Ltd., Zurich (CH)

(21) Appl. No.: 11/547,417

(22) PCT Filed: Apr. 5, 2005
(86) PCT No.: PCT/IB2005/000882

§ 371 Date: Sep. 29, 2006

(30) Foreign Application Priority Data
Apr. 5, 2004 (AT) A 599/2004

(51) Int. Cl. C04B 28/14; C04B 18/08

(52) U.S. Cl. 106/707; 106/782

(57) ABSTRACT

In a method for the production of high-strength, acid-resistant concrete by use of water, hydraulic binder and aggregates, a hydraulic binder containing aluminosilicates, calciumsulfate and an activator containing salts of alkalimetals is applied wherein the aluminosilicates are chosen from the group consisting of furnace slag, clay, marl and industry-by-products like flue-ash with the requirement that the Al₂O₃-content of the binder is greater than 5% (w/w) and that furnace slag is present in an amount less than 35% (w/w) of the binder and that cement kiln dust in amounts from 1 to 20% (w/w) of the binder is applied as activator whereby the hydraulic activator is applied in amounts >400 kg per m³ concrete safeguarding a water/binder ratio from 0.25 to 0.40.

The invention relates to a method for the production of high-strength, acid-resistant concrete by use of water, hydraulic binder and aggregates.

For the production of concrete different hydraulic binders are known whose composition shall safeguard the respective best possible combination of the desired qualities of the product. In particular, cements are known that a featuring a high a resistance at an early stage with, at the same time, good and end resistances. A further constitutive characteristic of concrete, however, is also the absence of cracks and hence shrinking as little as possible during hardening as well as the resistance against chemicals. All together the respective hydraulic binders mostly are optimised for one of the desired properties. Super sulphated metallurgical cements based on the addition of calcium-sulphate to the cement are standardized to the largest extent and contain at least 75% (w/w) hackled, granulated furnace slag and more than 5% (w/w) SO₃ in the form of calcium-sulphate additives, whereby at the same time at the most 5% (w/w) slaked lime, portland-cement-clinker or portland-cement are contained. If higher amounts of natural aluminium-silicates shall be applied and the respective portion of furnace slag shall be reduced this mostly results in that the desired stability values are not achieved offhand and in particular that the shrinking performance becomes more unfavourable so that the hazard of the formation of cracks can rise. For a good resistance against chemicals it is, in turn, required to create a particularly dense concrete, which stays free of cracks and features low permeability to gas. In turn, when a respectively tight concrete shall be formed as a rule compromises with respect to the resistance at an early stage and to the end resistance have to be made, when respective natural aluminium-silicates, for example flue-ash, shall be applied.

For the improvement of the resistance at an early stage in such a super sulphated binder with a respectively lower portion of furnace slag modification with respect to the applied activators are hence equally required as well as further accompanying measures to be taken in order to safeguard the desired resistance against chemicals and the desired resistance and in particular a high resistance at an early stage and a high end resistance with a permeability to gas as low as possible.

The invention is hence directed to provide a method for the production of high-strength acid resistant concrete in which as many of the initially mentioned terms can safely be achieved even with reduced application of furnace slag.

To solve this object the inventive method generally consists in that a hydraulic binder containing aluminosilicates, calciumsulfate and an activator containing salts of alkalimetals is applied wherein the aluminosilicates are chosen from the group consisting of furnace slag, clay, marl and industry-by-products like flue-ash with the requirement that the Al₂O₃-content of the binder is greater than 5% (w/w) and that furnace slag is present in an amount less than 35% (w/w) of the binder and cement kiln dust in amounts from 1 to 20% (w/w) of the binder is applied as activator whereby the hydraulic activator is applied in amounts >400 kg per m³ concrete safeguarding a water/binder ratio from 0.25 to 0.40. According to the invention a minimum of a specific hydraulic binder is thus suggested which in addition to calciumsulfate contains alkaliactivators in the specified amounts in which binder the portion of furnace slag can be limited to between 20 and 35% (w/w) and by which overall a particularly good shrinking performance can be safeguarded. By adding such a hydraulic binder in amounts of more than 400 kg per m³ and at the same time keeping the water/cement (W/C) ratio at relatively low values between 0.25 to 0.40 it can be safeguarded that the formation of cracks can be avoided and at the same time an acid-resistant, high-strength, dense concrete can be obtained. In particular, the use of cement kiln dust as the activator allows to do without OH-ions whereby the cement kiln dust also provides SO₃ in a manner favourable for the strength.

Advantageously the method is conducted such that the water/binder ratio is adjusted between 0.30 and 0.35 whereby plastification agents in amounts from 0.01 to 1% (w/w) can be added.

The invention will in the following be exemplified by way of exemplary embodiment. As the hydraulic binder herein a binder was applied according to the following composition.

| | |
|---|---|
| Cement kiln dust | 10% (w/w) |
| Furnace slag | 20% (w/w) |
| CaSO4 (anhydrite) | 15% (w/w) |
| Marl | 37% (w/w) |
| Basalt | 17% (w/w) |

When deploying 425 kg/m³ of the above-mentioned cement safeguarding the W/C factor of 0.35 the following resistances at an 0₂ permeability (*E-16m²) of 0.1572 have been measured.

| | | |
|---|---|---|
| CS (MPa) | 1 day | 14.1 |
| | 7 days | 31.3 |
| | 28 days | 40.5 |
| | 90 days | 48.6 |

Safeguarding a W/C factor of 0.30 and when deploying 450 kg/m³ of the above-mentioned cement and with addition of 0.7% (w/w) naphtalinesulfonate the following resistances at a 02 permeability (*E-16m²) of 0.118 where obtained.

| | | |
|---|---|---|
| CS (MPa) | 1 day | 18.4 |
| | 7 days | 37.3 |
| | 28 days | 44.5 |
| | 90 days | 52 |

The concrete features improved resistance against chemicals and absence of cracks.

1. Method for the production of high-strength, acid-resistant concrete by use of water, hydraulic binder and aggregates, wherein
a hydraulic binder containing aluminosilicates, calcium sulfate and an activator containing salts of alkali metals is applied, wherein the aluminosilicates are one or more chosen from the group consisting of furnace slag, clay, marl and industry-by-products,
an Al₂O₃-content of the binder is greater than 5% (w/w),
furnace slag is present in an amount less than 35% (w/w) of the binder, and
cement kiln dust in amounts from 1 to 20% (w/w) of the binder is applied as a hydraulic activator, whereby the hydraulic activator is applied in amounts greater than 400 kg per m³ concrete, safeguarding a water/binder ratio from 0.25 to 0.40.

2. Method according to claim 1, wherein the water/binder ratio is adjusted between 0.30 and 0.35.

3. Method according to claim 1, wherein plastification agents in amounts from 0.01 to 1% (w/w) are added.

4. Method according to claim 2, wherein plastification agents in amounts from 0.01 to 1% (w/w) are added.

5. Method according to claim 1, wherein the aluminosilicates are industry-by-products.

6. Method according to claim 5, wherein the industry-by-products are flue ash.
